(19) United States
(12) Patent Application Publication
(10) Pub. No.: US 2013/0075491 A1
(43) Pub. Date: Mar. 28, 2013

(54) Sprinkler Structure

(71) Applicant: Chen-Fu Hung, Changhua County (TW)

(72) Inventor: Chen-Fu Hung, Changhua County (TW)

(73) Assignee: RUEY RYH ENTERPRISE CO., LTD., Changhua County (TW)

(21) Appl. No.: 13/239,552

(22) Filed: Sep. 22, 2011

(51) Int. Cl. B05B 3/00

(52) U.S. Cl. 239/263.3

(57) ABSTRACT

A sprinkler structure includes a shell base, a water nozzle, a plurality of spiracles, a water conveyance element, an eccentric gear device, a drive gear device, and a fixing base. The eccentric gear device performs an eccentric movement in responding to an external force, and drives the water conveyance element to perform a reciprocating pivotal turning action. The drive gear device is disposed inside the shell base and is coupled to the eccentric gear device. The drive gear device is driven by the water current to rotate, so that the eccentric gear device drives the water conveyance element to perform the reciprocating pivotal turning action. The water nozzle is driven by the reciprocating pivotal turning action to change the angle of the water outlet surface continuously within an angle range. The fixing base is connected to the water nozzle and the shell base.

### BACKGROUND

1. Field of Invention

The present invention relates to a sprinkler structure and more particularly to a sprinkler structure which has an eccentric gear device and a drive gear device to drive a water nozzle to change the direction of spraying.

2. Related Art

In order to create beautiful visual effects and a feeling of comfort and spacious, many suburban scenic spots, areas in front of office buildings or residential courtyards have greenswards planted to obtain the abovementioned effects. Presently, most greenswards are transplanted so that the roots are not deeply planted in the soil to absorb water; therefore they have to be sprayed with water regularly. Furthermore, besides the aforementioned greenswards; farmlands and crops grown in gardens also need to be watered regularly in order to grow smoother and faster for harvesting.

For small sized farmlands, greenswards and vegetable gardens, manpower is adequate to take care of watering. But sprinklers are required for larger sized farmlands, greenswards and vegetable gardens in order to achieve the task. FIG. 1 shows a structure of a conventional sprinkler. It is clearly shown in the drawing that the sprinkler includes a sprinkler body 10, a spiracle 11 disposed on a side of the sprinkler body 10, and the spiracle 11 is pointed upward slightly at an inclined angle. The sprinkler further includes a turning element 12 and a limiting element 13. By the arrangement of the turning element 12 and the limiting element 13, the sprinkler in FIG. 1 performs reciprocating turns and the spiracle 11 projects parabolic water columns 14 to achieve the purpose of irrigation.

However, the abovementioned conventional sprinkler 1 is widely used and a drawback is discovered from experience. As shown in FIG. 1, obviously, the parabolic water columns 14 projected from the spiracle 11 are mainly landed on a peripheral area, only a small amount of water is landed on an area near the sprinkler. Therefore the spraying is done unevenly. Even though the conventional sprinkler and suchlike ones have a structure for adjusting the elevation of spraying, it is not so helpful for improving the drawback of uneven spraying. Furthermore, dozens or even hundreds of sprinklers are required for large sized farmlands, greenswards or vegetable gardens; it is very troublesome, non-effective and time-wasting for users to employ manpower to adjust the angle of the sprinkler.

### SUMMARY

Aspects of the present invention improve over the abovementioned drawback of the prior technology. A sprinkler structure of the present invention overcomes shortfalls of prior art by including a combination of the following elements. A shell base includes a water inlet hole for water current to flow in; a water nozzle which has an water outlet surface for water to come out, a plurality of spiracles is disposed on the water outlet surface for spraying water; a water conveyance element which is disposed on the shell base and is connected to the water nozzle, and the water conveyance element conveys the water current from the water inlet hole to the water nozzle; an eccentric gear device which is disposed on the shell base and is coupled to the water conveyance element, the eccentric gear device will perform an eccentric movement in responding to an external force, and thus drive the water conveyance element to perform a reciprocating pivotal turning action; a drive gear device which is disposed inside the shell base and it is coupled to the eccentric gear device, after the water current is flowed in from the water inlet hole, the drive gear device will be driven by the water current to turn, so that the eccentric gear device will drive the water conveyance element to perform the reciprocating pivotal turning action, therefore the water nozzle is driven by the reciprocating pivotal turning action to change the angle of the water outlet surface continuously within an angle range; and a fixing base which is connected to the water nozzle and the shell base for fixing the water nozzle and the shell base.

According to one embodiment of a sprinkler structure of the present invention, it further includes a spray angle adjusting element which is fixed on the water nozzle and also is rotatablely ringed on the water conveyance element. The spray angle adjusting element drives the water nozzle to turn in responding to an external turning force, so as to adjust the water outlet surface to a suitable angle.

According to one embodiment of to a sprinkler structure of the present invention, the shell base comprises a drive gear device supporting bracket, the supporting bracket has a first supporting bracket assembly and a second supporting bracket assembly to support the drive gear device, the first supporting bracket assembly has a first hole set, while the second supporting bracket assembly has a second hole set; a cover which has a water conveyance element hole and a drive gear device hole provided for the water conveyance element and the drive gear device to be disposed through them respectively; and a limit protrusion which is disposed on the cover for limiting the eccentric gear device to perform the eccentric movement within a limited range.

According to another embodiment of a sprinkler structure of the present invention, the water conveyance element comprises a water conveyance pipe which goes through the water conveyance element hole of the cover, for conveying the water current flowed in from the water inlet hole to the water nozzle; and a cam which is ringed on the water conveyance pipe and is connected to the eccentric gear device, the cam is driven by the eccentric movement of the eccentric gear device, in order to perform the reciprocating pivotal turning action to drive the water conveyance pipe to turn pivotally.

According to a further embodiment of a sprinkler structure of the present invention, the eccentric gear device comprises an eccentric gear which includes an eccentric gear chute and a fixing hole, the fixing hole is for connecting to the drive gear device; and a drive bar which has a protrusion, a first chute and a second chute. The protrusion is coupled inside the eccentric gear chute; the first chute is coupled to the limit protrusion of the shell base; while the second chute is coupled to the cam of the water conveyance element. When the drive gear device turns, the eccentric gear chute performs the eccentric movement around the protrusion as its axis, and drives the first chute to perform the reciprocating pivotal turning action around the limit protrusion as its axis, so that the second chute drives the cam to perform the reciprocating pivotal turning action.

According to an alternative embodiment of a sprinkler structure of the present invention, the drive gear device comprises a turbine component which is composed of a turbine blade and a lead screw, and it also has a first axle fixing hole, a first fixing axle goes through the first axle fixing hole and the first hole set of the first supporting bracket assembly to fix the turbine component, the turbine blade is driven by the water current flowed in from the water inlet hole to turn, so as to drive the lead screw to turn; a coupling gear which is composed of a gear portion and a lead screw portion, and it also has a second axle fixing hole, a second fixing axle goes through the second axle fixing hole and the second hole set of the second supporting bracket assembly to fix the coupling gear, the gear portion is meshed with the lead screw of the turbine component, the gear portion turns in responding to the turning of the lead screw of the turbine component, and at the same time, the lead screw portion is also driven to turn; and an uni-directional gear component which includes an uni-directional gear and an uni-directional gear axle; the uni-directional gear axle goes through an uni-directional gear hole of the uni-directional gear, the drive gear device hole, the fixing hole of the eccentric gear and the first chute of the drive bar. The uni-directional gear is meshed with the gear portion of the coupling gear. The uni-directional gear turns in responding to the turning of the lead screw portion of the coupling gear; and at the same time, the uni-directional gear axle is driven to turn, so as to drive the eccentric gear device to perform the eccentric movement.

Based on the abovementioned structures according to a sprinkler structure of the present invention, the fixing base comprises a first fixing axle which is parallel to the water nozzle; a second fixing axle which is parallel to the water nozzle and the first fixing axle; a first fixing sleeve component which is sleeved and fixed on one end of the first fixing axle, the second fixing axle and the water nozzle; and a second fixing sleeve component which is connected to the shell base and is sleeved and fixed on another end of the first fixing axle and the second fixing axle.

The present invention will become more fully understood by reference to the following detailed description thereof when read in conjunction with the attached drawings.

### BRIEF DESCRIPTION OF THE DRAWINGS

FIG. 1 is an illustration of a sprinkler structure of a prior art.

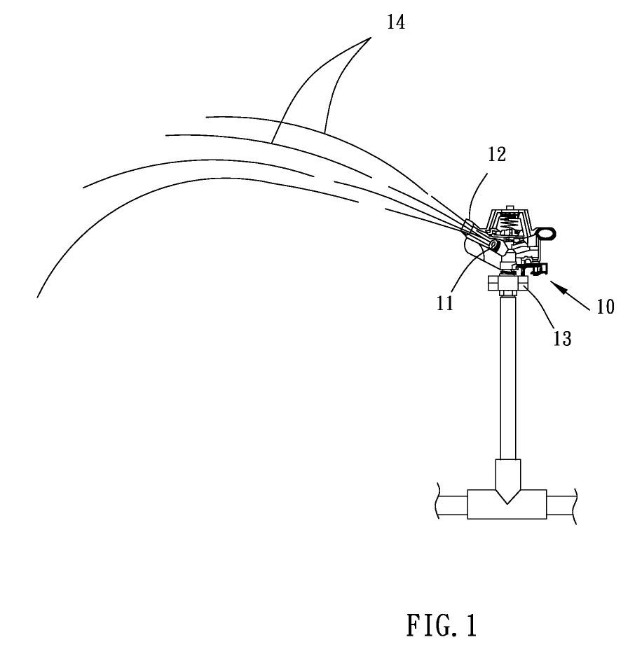

FIG. 2(a) is a perspective view of a sprinkler structure according to one embodiment of the invention.

FIG. 2(b) is a perspective exploded view of a sprinkler structure according to one embodiment of the invention.

FIG. 2(c) is a perspective view of an eccentric gear of a sprinkler structure according to one embodiment of the invention.

FIG. 3(a) is a perspective view of the interior of a shell base according to one embodiment of the invention.

FIG. 3(b) is a perspective view of operations of an eccentric gear device of a sprinkler structure according to one embodiment of the invention.

Corresponding reference characters indicate corresponding parts throughout the drawings.

### DETAILED DESCRIPTION

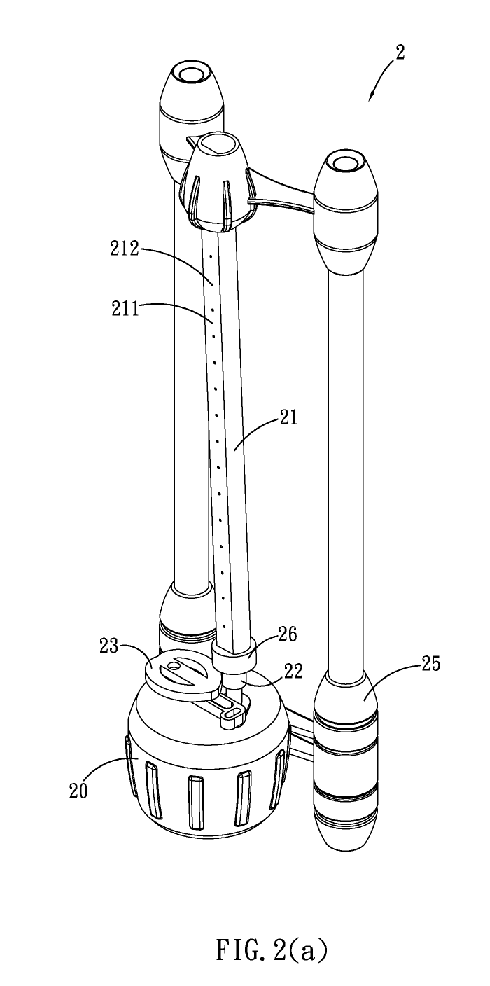

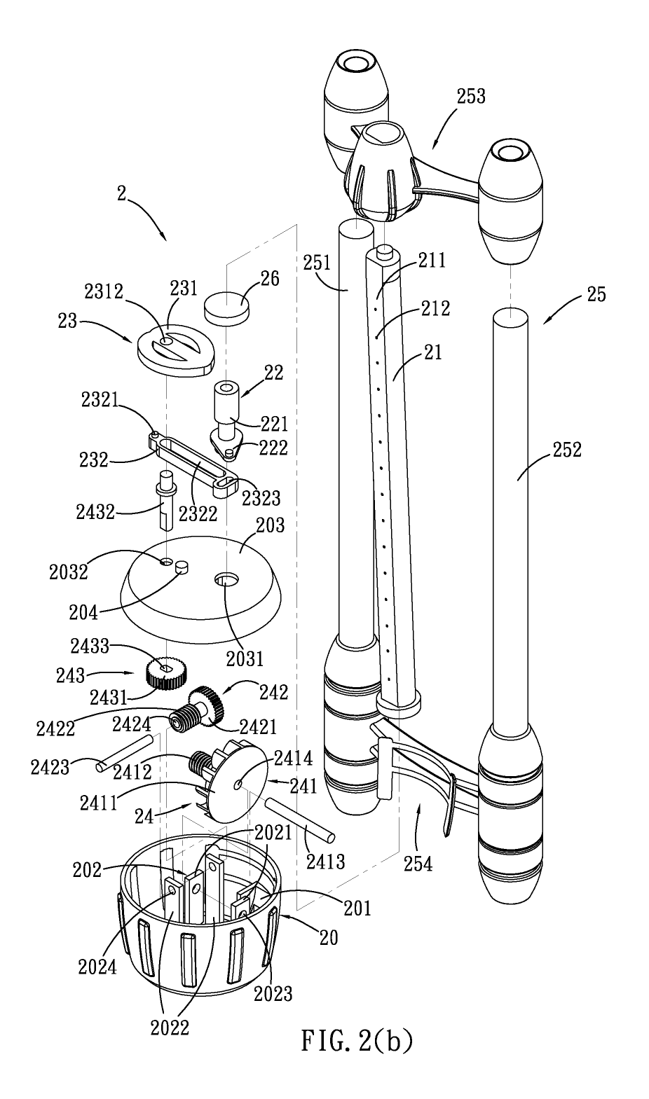

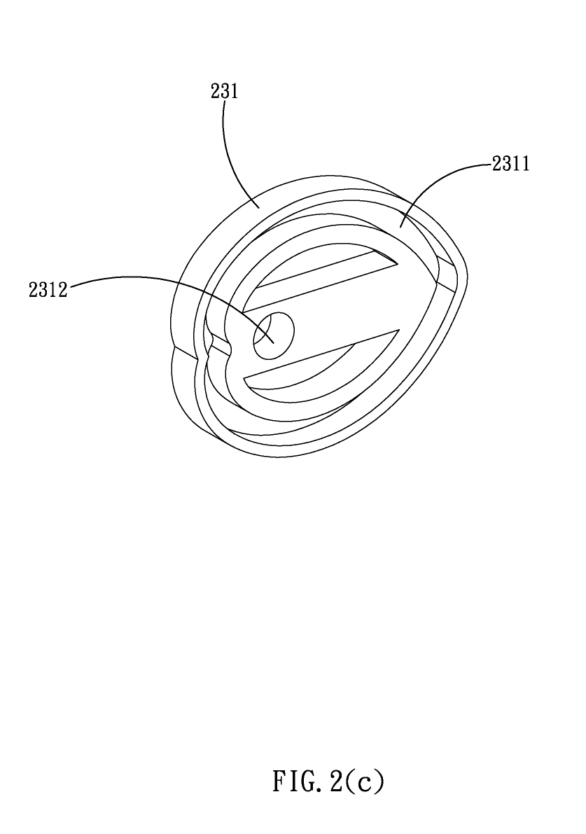

Referring to FIGS. 2(a), 2(b) and 2(c), they show a preferred embodiment of a sprinkler structure 2 of the present invention which is developed to improve the drawbacks of conventional techniques and means. It is clearly shown in the drawings that, a sprinkler structure 2 of the present invention mainly comprises a shell base 20, a water nozzle 21, a water conveyance element 22, an eccentric gear device 23, a drive gear device 24, a fixing base 25 and a spray angle adjusting element 26. The shell base 20 has a water inlet hole 201 for supplying water current. The water nozzle 21 has a water outlet surface 211, a plurality of spiracles 212 is disposed on the water outlet surface 211 for spraying water. The water conveyance element 22 which is disposed on the shell base 20 and is connected to the water nozzle 21, and the water conveyance element 22 conveys the water current from the water inlet hole 201 to the water nozzle 21.

The spray angle adjusting element 26 is fixed or secured on the water nozzle 26 and also is rotatablely ringed on the water conveyance element 22. The spray angle adjusting element 26 drives the water nozzle 21 to turn in responding to an external turning force, so as to adjust the water outlet surface 211 to a suitable angle. The fixing base 25 is connected to the water nozzle 21 and the shell base 20 for fixing or securing the water nozzle 21 and the shell base 20. According to embodiment of the invention shown in the sprinkler structure 2, the arrangement of the eccentric gear device 23 and the drive gear device 24 improves over similar devices in the prior art. For example, the eccentric gear device 23 is disposed on the shell base 20 and is coupled to the water conveyance element 22. In addition, the eccentric gear device 23 will perform an eccentric movement in responding to an external force, and thus drives the water conveyance element 22 to perform a reciprocating pivotal turning action. The drive gear device 24 is disposed inside the shell base 20 and it is coupled to the eccentric gear device 23. After the water current is flowed in from the water inlet hole 201, the drive gear device 24 will be driven by the water current to turn, so that the eccentric gear device 23 will drive the water conveyance element 22 to perform the reciprocating pivotal turning action; therefore the water nozzle 21 is driven by the reciprocating pivotal turning action to change the angle of the water outlet surface 211 continuously within an angle range. Detailed description of a sprinkler structure 2 of the present invention is further explained below.

Referring to FIG. 2(b), the abovementioned shell base 20 further includes a drive gear device supporting bracket 202, a cover 203 and a limit protrusion 204. The drive gear device supporting bracket 202 has a first supporting bracket assembly 2021 and a second supporting bracket assembly 2022 to support the drive gear device 24. The first supporting bracket assembly 2021 has a first hole set 2023, while the second supporting bracket assembly 2022 has a second hole set 2024. The cover 203 has a water conveyance element hole 2031 and a drive gear device hole 2032 provided for the water conveyance element 22 and the drive gear device 24 to be disposed through them respectively. The limit protrusion 204 is used to limit the eccentric gear device 23 to perform the eccentric movement within a limited range. The water conveyance element 22 includes a water conveyance pipe 221 and a cam 222. The water conveyance pipe 221 goes through the water conveyance element hole 2031 of the cover 203, for conveying the water current flowed in from the water inlet hole 201 to the water nozzle 21. The water conveyance pipe 221 goes through the cam 222, and the cam 222 is connected to the eccentric gear device 23; the cam 222 is driven by the eccentric movement of the eccentric gear device 23, so as to perform the reciprocating pivotal turning action to drive the water conveyance pipe 221 to turn pivotally.

Referring to FIGS. 2(b) and 2(c), the abovementioned eccentric gear device 23 includes an eccentric gear 231 and a drive bar 232. The eccentric gear 231 includes an eccentric gear chute 2311 (as shown in FIG. 2(c)) and a fixing hole 2312. The fixing hole 2312 is for connecting with the drive gear device 24. The drive bar 232 has a protrusion 2321, a first chute 2322 and a second chute 2323. The protrusion 2321 is coupled inside the eccentric gear chute 2311. The first chute 2322 is coupled to the limit protrusion 204 of the shell base 20; while the second chute 2323 is coupled to the cam 222 of the water conveyance element 22. When the drive gear device 24 turns, the eccentric gear chute 2311 performs the eccentric movement around the protrusion 2321 as its axis; and drives the first chute 2322 to perform the reciprocating pivotal turning action around the limit protrusion 204 as its axis; so that the second chute 2323 drives the cam 222 to perform the reciprocating pivotal turning action.

Referring to FIG. 2(b), the abovementioned drive gear device 24 includes a turbine component 241, a coupling gear 242 and an uni-directional gear component 243. The turbine component 241 is composed of a turbine blade 2411 and a lead screw 2412, and it also has a first axle fixing hole 2414. A first fixing axle 2413 goes through the first axle fixing hole 2414 and the first hole set 2023 of the first supporting bracket assembly 2021 to fix the turbine component 241. The turbine blade 2411 is driven by the water current flowed in from the water inlet hole 201 to turn, so as to drive the lead screw 2412 to turn. The coupling gear 242 is composed of a gear portion 2421 and a lead screw portion 2422, and it also has a second axle fixing hole 2424. A second fixing axle 2423 goes through the second axle fixing hole 2424 and the second hole set 2024 of the second supporting bracket assembly 2022 to fix the coupling gear 242. The gear portion 2421 is meshed with the lead screw 2412 of the turbine component 241. The gear portion 2421 turns in responding to the turning of the lead screw 2412 of the turbine component 241; and at the same time, the lead screw portion 2422 is also driven to turn. The uni-directional gear component 243 includes an uni-directional gear 2431 and an uni-directional gear axle 2432. The uni-directional gear axle 2432 goes through an uni-directional gear hole 2433 of the uni-directional gear 2431, the drive gear device hole 2032, the fixing hole 2312 of the eccentric gear 231 and the first chute 2322 of the drive bar 232. The uni-directional gear 2431 is meshed with the gear portion 2421 of the coupling gear 242. The uni-directional gear 2431 turns in responding to the turning of the lead screw portion 2422 of the coupling gear 242; and at the same time, the uni-directional gear axle 2432 is driven to turn, so as to drive the eccentric gear device 23 to perform the eccentric movement.

Referring to FIG. 2(b), the abovementioned fixing base 25 includes a first fixing axle 251, a second fixing axle 252, a first fixing sleeve component 253 and a second fixing sleeve component 254. The first fixing axle 251 and the second fixing axle 252 are parallel to the water nozzle 21. The first fixing sleeve component 253 is sleeved and fixed on one end of the first fixing axle 251, the second fixing axle 252 and the water nozzle 21. The second fixing sleeve component 254 is connected to the shell base 20 and is sleeved and fixed on another end of the first fixing axle 251 and the second fixing axle 252. The water nozzle 21 and the shell base 20 are fixed with each other by the fixing base 25.

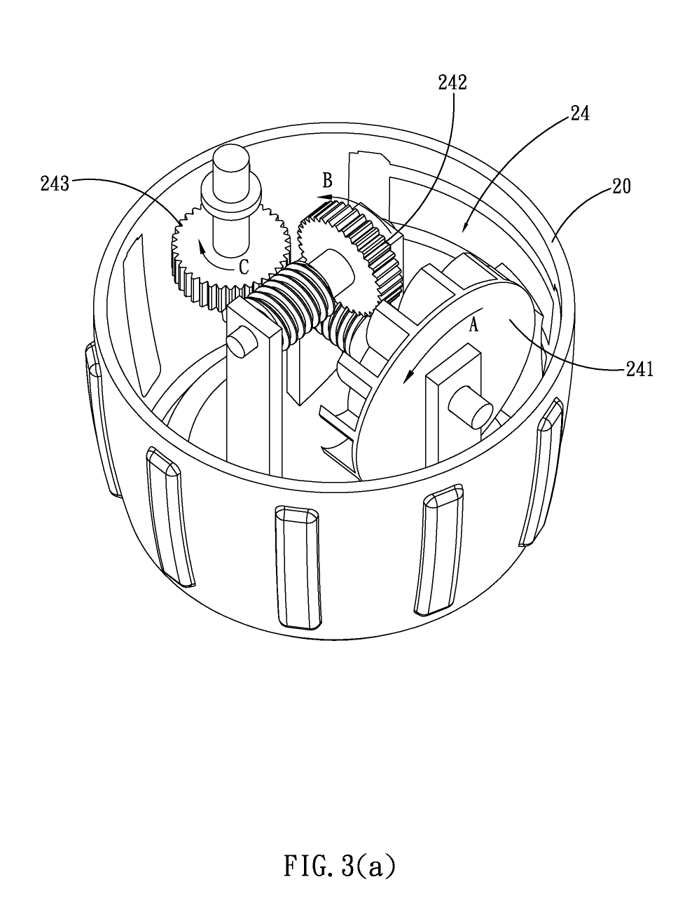

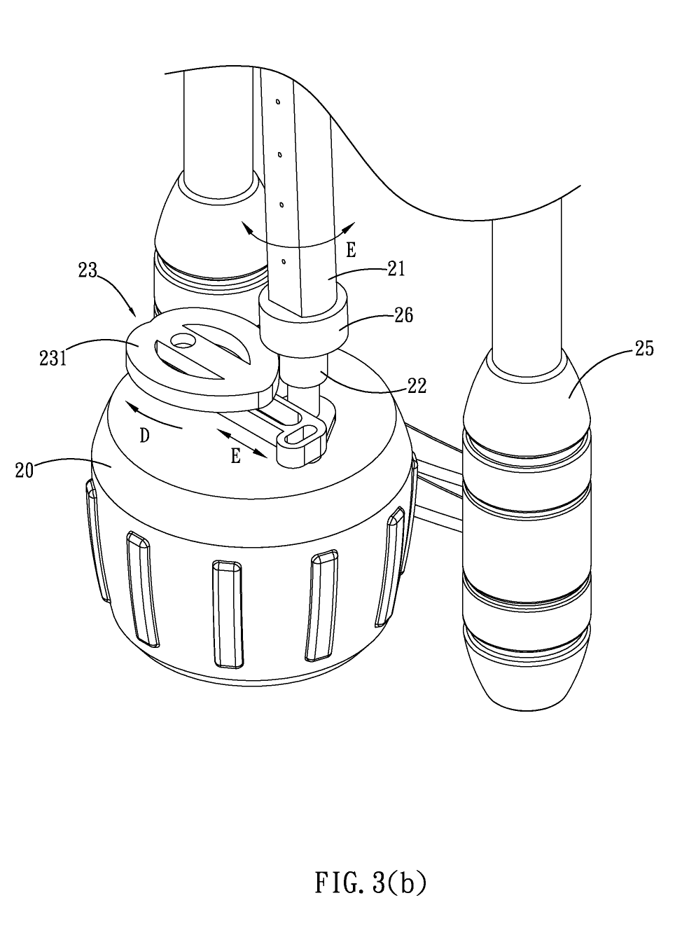

Referring to FIGS. 3(a) and 3(b), which are illustrations of operation of a sprinkler 2 of the present invention. FIG. 3(a) clearly shows that, when water current flows in from the water inlet hole 201 (as shown in FIG. 2(b)), the water current will drive the turbine blade 2411 of the turbine component 241 to turn (as indicated with a direction arrow A in FIG. 3(a)); at the same time, the lead screw 2412 of the turbine component 241 will also turn. Because the lead screw 2412 is meshed with the coupling gear 242, the turning of the lead screw 2412 will drive the coupling gear 242 to turn (as indicated with a direction arrow B in FIG. 3(a)). When the coupling gear 242 turns, its lead screw portion 2422 will drive the uni-directional gear component 243 to turn (as indicated with a direction arrow C in FIG. 3(a)). At this moment, the uni-directional gear axle 2432 of the uni-directional gear component 243 will also be driven to turn. As shown in FIG. 3(b), when the uni-directional gear axle 2432 turns, it will drive the eccentric gear 231 of the eccentric gear device 23 to perform the eccentric movement in the direction as indicated with a direction arrow D in FIG. 3(b); which indicates that the eccentric gear chute 2311 of the eccentric gear 231 (as shown in FIG. 2(c)) performs the eccentric movement around the protrusion 2321 of the drive bar 232 as its axis.

At this moment, the drive bar 232 will be driven by the eccentric movement of the eccentric gear device 23, so as to perform the reciprocating pivotal turning action in the direction as indicated with a direction arrow E in FIG. 3(b). Finally, the cam 222 of the water conveyance element 22 will also be driven to perform the reciprocating pivotal turning action; while the water conveyance pipe 221 of the water conveyance element 22, and the water nozzle 21 connected to the water conveyance element 22 will also perform the reciprocating pivotal turning action in the direction as indicated with a direction arrow E in FIG. 3(b).

Moreover, aspects of the invention illustrated in the exemplary embodiment described in the sprinkler structure 2 of the present invention disclose an improved linkage relationship between the water conveyance element 22, the eccentric gear device 23 and the drive gear device 24; by the connection and interaction between the water conveyance element 22, the eccentric gear device 23 and the drive gear device 24; the water nozzle 21 of a sprinkler structure 2 of the present invention will be able to change the angle of the water outlet surface 211 continuously within an angle range, so that the spraying area is enlarged; when it is used together with the spray angle adjusting element 26, a wider spraying angle and spraying area are covered for a sprinkler structure 2 of the present invention. Therefore, a sprinkler structure 2 of the present invention can effectively improve over the drawbacks of uneven spraying of conventional sprinkles.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A sprinkler structure comprising:
a shell base having a water inlet hole for water current to flow in;
a water nozzle having a water outlet surface, said water outlet surface including a plurality of spiracles is disposed thereon for spraying water;
a water conveyance element being disposed on said shell base, said water conveyance element being connected to said water nozzle, said water conveyance element conveying said water current from said water inlet hole to said water nozzle;
an eccentric gear device being disposed on said shell base and being coupled to said water conveyance element, said eccentric gear device performing an eccentric movement in responding to an external force and driving said water conveyance element to perform a reciprocating pivotal turning action;
a drive gear device being disposed inside said shell base, said drive gear device being coupled to said eccentric gear device, wherein said drive gear device is rotated in response to said water current flowing in from said water inlet hole so that said eccentric gear device drives said water conveyance element to perform said reciprocating pivotal turning action, wherein said water nozzle is driven by said reciprocating pivotal turning action to alter an angle of said water outlet surface continuously within an angle range; and
a fixing base connected to said water nozzle and said shell base for securing said water nozzle and said shell base.

2. The sprinkler structure as claimed in claim 1, further comprising a spray angle adjusting element fixed on said water nozzle, said spray angle adjusting element being rotatablely ringed on said water conveyance element, said spray angle adjusting element driving said water nozzle to turn in responding to an external turning force, so as to adjust said water outlet surface to a suitable angle.

3. The sprinkler structure as claimed in claim 1, wherein said shell base comprises:
a drive gear device supporting bracket supporting said drive gear device by a first supporting bracket assembly and a second supporting bracket assembly, wherein said first supporting bracket assembly has a first hole set, while said second supporting bracket assembly has a second hole set;
a cover having a water conveyance element hole and a drive gear device hole provided for said water conveyance element and said drive gear device, said cover being disposed through said water conveyance element and said drive gear device respectively; and
a limit protrusion disposed on said cover, said limit protrusion limiting said eccentric gear device to perform said eccentric movement within a limited range.

4. The sprinkler structure as claimed in claim 3, wherein said water conveyance element comprises:
a water conveyance pipe extending through said water conveyance element hole of said cover for conveying said water current flowed in from said water inlet hole to said water nozzle; and
a cam being ringed on said water conveyance pipe and being connected to said eccentric gear device, said cam being driven by said eccentric movement of said eccentric gear device so as to perform said reciprocating pivotal turning action to drive said water conveyance pipe to turn pivotally.

5. The sprinkler structure as claimed in claim 4, wherein said eccentric gear device comprises:
an eccentric gear having an eccentric gear chute and a fixing hole, wherein said fixing hole is for connecting with said drive gear device; and
a drive bar having a protrusion, a first chute and a second chute, said protrusion being coupled inside said eccentric gear chute, said first chute being coupled to said limit protrusion of said shell base, wherein, in response to turning of said drive gear device, said eccentric gear chute performs said eccentric movement around said protrusion while said second chute is coupled to said cam of said water conveyance element, wherein said eccentric gear chute drives said first chute to perform said reciprocating pivotal turning action around said limit protrusion so that said second chute drives said cam to perform said reciprocating pivotal turning action.

6. The sprinkler structure as claimed in claim 5, wherein said drive gear device comprises:
a turbine component including a turbine blade and a lead screw, said turbine component having a first axle fixing hole and a first fixing axle extending through said first axle fixing hole and said first hole set of said first supporting bracket assembly to fix said turbine component, said turbine blade being driven by said water current flowed in from said water inlet hole to turn so as to drive said lead screw to turn;
a coupling gear including a gear portion and a lead screw portion, said coupling gear including a second axle fixing hole and a second fixing axle extending through said second axle fixing hole and said second hole set of said second supporting bracket assembly to secure said coupling gear, said gear portion being meshed with said lead screw of said turbine component, said gear portion rotating about in response to turning of said lead screw of said turbine component, and at the same time, said lead screw portion is also driven to turn; and
an uni-directional gear component having an uni-directional gear and an uni-directional gear axle, said uni-directional gear axle goes through an uni-directional gear hole of said uni-directional gear, said drive gear device hole, said fixing hole of said eccentric gear and said first chute of said drive bar, said uni-directional gear being meshed with said gear portion of said coupling gear, said uni-directional gear rotating about in response to turning of said lead screw portion of said coupling gear, and, at the same time, said uni-directional gear axle being driven to turn so as to drive said eccentric gear device to perform said eccentric movement.

7. The sprinkler structure as claimed in claim 1, wherein said fixing base comprises:
a first fixing axle in parallel to said water nozzle;
a second fixing axle in parallel to said water nozzle and said first fixing axle;
a first fixing sleeve component being sleeved and secured on one end of said first fixing axle, said second fixing axle and said water nozzle; and
a second fixing sleeve component being connected to said shell base and being sleeved and secured on another end of said first fixing axle and said second fixing axle.
